(19) United States
(12) Patent Application Publication
(10) Pub. No.: US 2018/0368493 A1
(43) Pub. Date: Dec. 27, 2018

(54) Facemask with Nonmetallic Nose Member and Method of Manufacturing Same

(71) Applicant: AVENT, INC., Alpharetta, GA (US)

(72) Inventor: Ajay Y. Houde, Johns Creek, GA (US)

(21) Appl. No.: 16/064,649

(22) PCT Filed: Dec. 23, 2015
(86) PCT No.: PCT/US2015/000268

§ 371 Date: Jun. 21, 2018

(51) Int. Cl. A41D 13/11; A62B 23/02; A62B 18/02

(52) U.S. Cl. CPC A41D 13/1107; A62B 18/02; A62B 23/025

(57) ABSTRACT

A protective disposable facemask includes a body having a top edge and a bottom edge, the top and bottom edges cooperating with each other to define a periphery that contacts a wearer's face. A first reactant material is deposited along the top edge, the first reactant material having a malleable unreacted state such that the top edge is conformable across the wearer's nose and face in the unreacted state. The first reactant material is reactable with a second reactant material to form a stiffened nose member that retains the conformed shape across the wearer's nose and face. A method of manufacturing the facemasks is also encompassed.

### FIELD OF THE INVENTION

The present invention relates generally to the field of protective facemasks, and more specifically to a facemask without a metal nose wire and a manufacturing process for such facemasks.

### BACKGROUND OF THE INVENTION

Various configurations of disposable filtering facemasks or respirators are known and may be referred to by various names, including “facemasks”, “respirators”, “filtering face respirators”, and so forth. For purposes of this disclosure, such devices are referred to generically as “facemasks.”

The ability to supply aid workers, rescue personnel, and the general populace with protective facemasks during times of natural disasters or other catastrophic events is crucial. For example, in the event of a pandemic, the use of facemasks that offer filtered breathing is a key aspect of the response and recovery to such event. For this reason, governments and other municipalities generally maintain a ready stockpile of the facemasks for immediate emergency use. However, the facemasks have a defined shelf life, and the stockpile must be continuously monitored for expiration and replenishing. This is an extremely expensive undertaking.

Recently, investigation has been initiated into whether or not it would be feasible to mass produce facemasks on an “as needed” basis during pandemics or other disasters instead of relying on stockpiles. For example, in 2013, the Biomedical Advanced Research and Development Authority (BARDA) within the Office of the Assistant Secretary for Preparedness and Response in the U.S. Department of Health and Human Services estimated that up to 100 million facemasks would be needed during a pandemic situation in the U.S., and proposed research into whether this demand could be met by mass production of from 1.5 to 2 million facemasks per day to avoid stockpiling. This translates to about 1,500 masks/minute. Current facemask production lines are capable of producing only about 100 masks/minute due to current technology and equipment restraints, which falls far short of the estimated goal. Accordingly, advancements in the manufacturing and production processes will be needed if the goal of “on demand” facemasks during a pandemic is to become a reality.

The various configurations of filtration facemasks include a flexible, malleable metal piece, known as “nose wire”, along the edge of the upper filtration panel to help conform the facemask to the user's nose and retain the facemask in place during use, as is well known. The nose wire may have a varying length and width between different sizes and mask configurations, but is generally cut from a spool in a continuous in-line process cutting and crimping process and then laid directly onto a running carrier nonwoven web (which may include a plurality of nonwoven layers) along an edge that becomes a top edge of the finished mask. The edge is subsequently sealed with a binder material, which also encapsulates and permanently holds the nose wire in place at the top edge. Transport and placement of the individual nose wires from the cutting/crimping station onto the carrier web must be precise to ensure the correct location of the nose wires in the finished face masks. For mass production of facemasks at the throughputs mentioned above, the production rates (throughput) of the individual nose wires from the cutting/crimping station and transport speed of the carrier web will necessarily be significantly higher as compared to conventional manufacturing lines.

Attachment of the nose wires contributes to much of the time and complexity of current facemask production. In addition, the nose wires of individual facemasks are difficult to recycle as they are metal and embedded into the nonwoven layers of the facemask.

Accordingly, the present invention addresses the aforementioned issues and provides a facemask without a nose wire that can be manufactured at the desired throughputs required during a pandemic as explained herein.

### SUMMARY OF THE INVENTION

Objects and advantages of the invention will be set forth in the following description, or may be obvious from the description, or may be learned through practice of the invention.

In one aspect, the present disclosure is directed to a protective facemask absent of a nose wire. The facemask has a body defining a top edge and a bottom edge that cooperate with each other to define a periphery that contacts a wearer's face. In particular, the top edge extends across the bridge of the wearer's nose and onto the cheek areas when the facemask is properly donned. A first reactant material is deposited along the top edge and in a dried unreacted state forms a malleable composition along the top edge that is conformable across the wearer's nose and face in the unreacted state when the mask is donned. The first reactant material is reactable with a second reactant material to form a stiffened nose member that retains the conformed shape across the wearer's nose and face.

The inventive facemask is not limited to a particular body style or type. For example, the body may be a trapezoidal “duckbill” configuration, or a flat, pleated configuration, as well as any other configuration of protective facemask that would otherwise utilize a nose wire.

In a certain embodiment, the top edge further comprises a binder material folded over the top edge, wherein the first reactant material is deposited on the body below the binder layer such that the binder layer is folded over the first reactant material.

In an alternate aspect, the first reactant material deposited on top of the folded over binder material so as to be directly exposed to atmosphere upon unwrapping the facemask.

In some embodiments, the deposition on the top edge is a single-component composition containing the first reactant material and the second reactant material is external to the facemask. The first reactant material is exposed to the second reactant material upon unsealing the facemask from a wrapper. For example, the second reactant material may be contained in the atmosphere or environment where the facemask is opened, such as humidity or moisture in the air. Alternately, the requisite moisture may be applied directly onto the first reactant material by the wearer, for example, from a sprayer or a moist wipe. With this embodiment, the first reactant material may be, for example, a crosslinkable polymeric material that crosslinks with moisture upon being exposed and then forms the stiffened nose member that retains the conformed shape manually induced in the top edge by the wearer upon donning the facemask. The crosslinkable polymeric material is, in certain embodiments, one of a cyanoacrylate or a polydimethyl siloxane that crosslinks with moisture present in the atmosphere upon being exposed.

In still other aspects, the deposition along the top edge may be a two-component composition that also includes the second reactant material. With this type of deposition, the reactants are retained separate and isolated from each other until the mask is donned by the wearer. For this, in certain embodiments, one or both of the first and second reactant materials are provided in encapsulated form and may homogeneously mixed with the other respective reactant material. The encapsulated reactants may be mixed in a carrier material, wherein the composition of carrier material and encapsulated reactants is deposited along the top edge.

When donning the facemask, the wearer manipulates (e.g., kneads or squeezes) the top edge to expose the encapsulated reactant(s). The reaction time of the reactants is sufficient to allow the wearer to conform the top edge across their nose and face prior the formation of the stiffened nose member.

In an example of the above embodiment, the first and second reactants may include a two-part acrylic resin, or a two-part epoxy system.

The present invention also includes various embodiments for manufacturing the above-described facemasks in a high throughput production line. The method includes, in the production line, forming a filter body of the facemask having a top edge and a bottom edge, the top and bottom edges cooperating with each other to define a periphery that contacts a wearer's face. At a station along the production line, a first reactant material is deposited along the top edge. The first reactant material may be the sole component of the deposition, or may be a component of a carrier material. The first reactant material has a malleable unreacted state when dried on the top edge such that the top edge is conformable across a wearer's nose and face in the unreacted state by manual manipulation. Upon donning, the first reactant material reacts with a second reactant material to form a stiffened nose member that retains the conformed shape across the wearer's nose and face. The method includes preventing the first reactant material from reacting with the second reactant material prior to the wearer donning and using the facemask.

One method embodiment includes applying a binder material to the top edge at a station along the production line, the binder material folded over the top edge. The first reactant material is deposited along the top edge under the binder material. Alternatively, the first reactant material is deposited on top of the binder material.

In certain embodiments, the second reactant material is external to the facemask, for example is present in the atmosphere or environment in which the facemask is intended to be used, wherein the preventing step includes sealing the facemask in wrapping material along the production line subsequent to deposition of the first reactant material to isolate the first reactant material from the second reactant material.

Alternatively, the second reactant material is also deposited along the top edge with the first reactant material. The method may include providing one or both of the first and second reactant materials in encapsulated form homogeneously mixed with the other respective reactant material, wherein the top edge is manipulated by the wearer prior to donning the facemask to release the encapsulated reactant(s).

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 illustrates a perspective view of a conventional respiratory facemask worn by a user, the facemask incorporating a nose wire to conform the facemask to the user's face;

FIG. 2 illustrates a top view of the conventional facemask of FIG. 1 in a folded state, with the nose wire depicted in dash lines underlying the top edge binder;

FIG. 3 illustrates a top view of the one embodiment of a facemask according to the present disclosure, particularly illustrating a reactive composition deposited along the top edge thereof;

FIG. 4 illustrates a cross-sectional view of the facemask of FIG. 3 taken along line 4-4;

FIG. 5 illustrates a top view of the one embodiment of a facemask according to the present disclosure, particularly illustrating a reactive composition deposited along the top edge thereof under the binder material layer;

FIG. 6 illustrates a cross-sectional view of the facemask of FIG. 5 taken along line 6-6;

FIG. 7 illustrates an embodiment wherein the nose member includes a first reactant material that reacts with a second reactant material in atmosphere or environment in which the facemask is used;

FIG. 8 illustrates an embodiment wherein the nose member includes a first reactant material and an encapsulated second reactant material;

FIG. 9 is a schematic representation of facemask production line in which embodiments of the present facemasks may be manufactured; and

FIG. 10 is a schematic representation of an alternate facemask production line in which embodiments of the present facemasks may be manufactured

### DETAILED DESCRIPTION OF REPRESENTATIVE EMBODIMENTS

Reference now will be made in detail to various embodiments of the invention, one or more examples of which are set forth below. Each example is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention covers such modifications and variations as come within the scope of the appended claims and their equivalents.

Generally, the present disclosure is directed to a protective facemask absent of a metallic nose wire that can be used in multiple applications, such as in the medical field or during a pandemic. For example, the facemask protective includes a body having a top edge and a bottom edge. The top and bottom edges cooperate with each other to define a periphery that contacts a wearer's face. Further, the top edge includes a first reactant material deposited thereon, for example as the only component of the deposition material or mixed with other components, such as a carrier material. In a dried unreacted state, the first reactant component forms a malleable composition along the top edge that is conformable across the wearer's nose and face when the mask is donned, as explained in greater detail below.

Thus, the reactant deposition material replaces the nose wire of conventional facemasks and provides many advantages not present in the prior art. For example, the reactant material can be carefully chosen such that the final reactive state is safe for human skin contact while stiffening into a nose member that retains the conformed state manipulated into the top edge by the wearer upon initially donning the facemask. In addition, the reactant material can be deposited at high-speeds in a facemask production line, thereby reducing manufacturing time and costs. Further, as the present facemasks do not contain metal, such facemasks can be easily recycled.

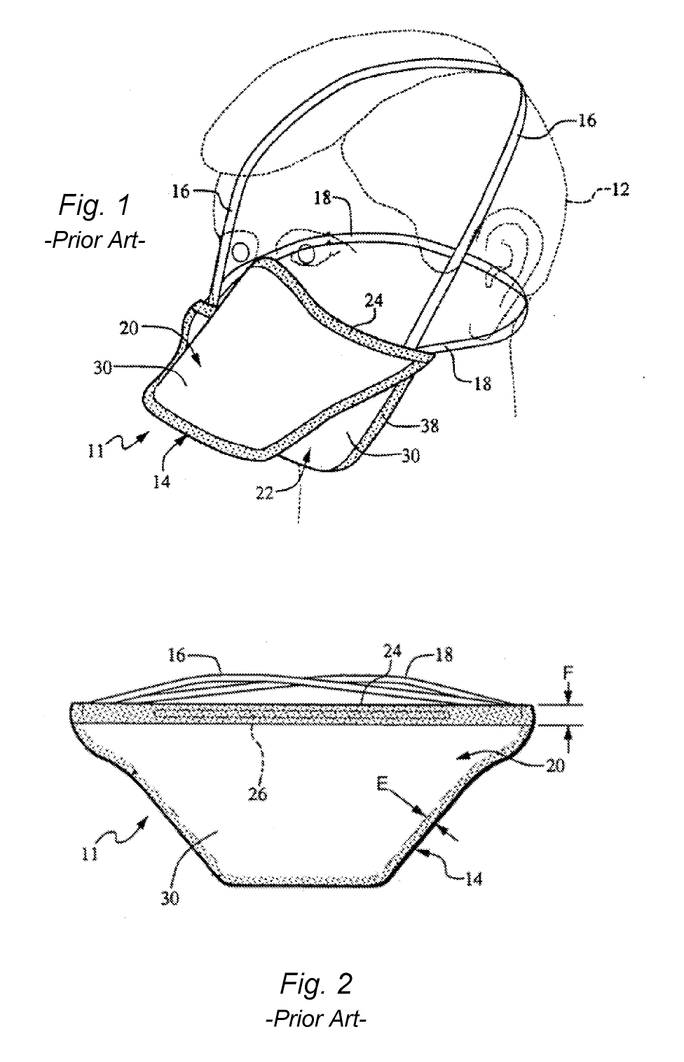

Various styles and configurations of conventional facemasks are well known, including flat pleated facemasks and duck-bill facemasks. For illustrative purposes only, aspects of the present facemasks and methods are described herein with reference to a particular type of respirator facemask often referred to in the art as a “duckbill” mask, as illustrated in FIG. 1.

Referring to FIGS. 1 and 2, a conventional duckbill facemask 11 is illustrated as being positioned on the face of wearer 12 shown in ghost lines. The mask 11 includes filter body 14 that is secured to wearer 12 by means of resilient and elastic straps or securing members 16 and 18. The filter body 14 includes an upper portion 20 and a lower portion 22, which have a generally identical trapezoidal configuration, and are bonded together, such as by thermal and/or ultrasonic bonding, along three sides. Such bonding adds important structural integrity to the facemask 11.

The facemask 11 has an open side and includes a top edge 24 configured for receipt of an elongated malleable metallic nose wire 26, such as an aluminum strip, so that the top edge 24 can be manipulated to closely fit the contours of the nose and cheeks of wearer 12. It has been suggested in the prior art that the malleable metallic member 26 may also be a moldable plastic member. With the exception of having the nose wire 26 located along the top edge 24 of upper portion 20, the upper and lower portions 20 and 22 may be identical and have the same material layers. The top edge 24 of upper portion 20 and the bottom edge 38 of the lower portion 22 cooperate with each other to define the periphery of mask 11 that contacts the face of wearer 12.

As shown in FIG. 1, the facemask 11 has the general shape of a cup or cone when placed on the face of wearer 12, thus providing the mask 11 with “off-the-face” benefits of a molded-cone style mask while still being easy for wearer 12 to carry the facemask 11 in a pocket prior to use. As is generally appreciated, “of-the-face” style masks provide a larger breathing chamber as compared to soft, pleated masks which contact a substantial portion of the wearer's face. Therefore, “off-the-face” masks permit cooler and easier breathing, and excessive heating of the air within filter body 14 and dizziness from prolonged periods of rebreathing exhaled air is minimized.

Blow-by associated with normal breathing of the wearer 12 is substantially eliminated by properly selecting the dimension and location of the nose wire 26 with respect to top edge of 24. The nose wire 26 is preferably positioned in the center of top edge 24 and has a length in the range of fifty percent (50%) to seventy percent (70%) of the total length of the top edge 24.

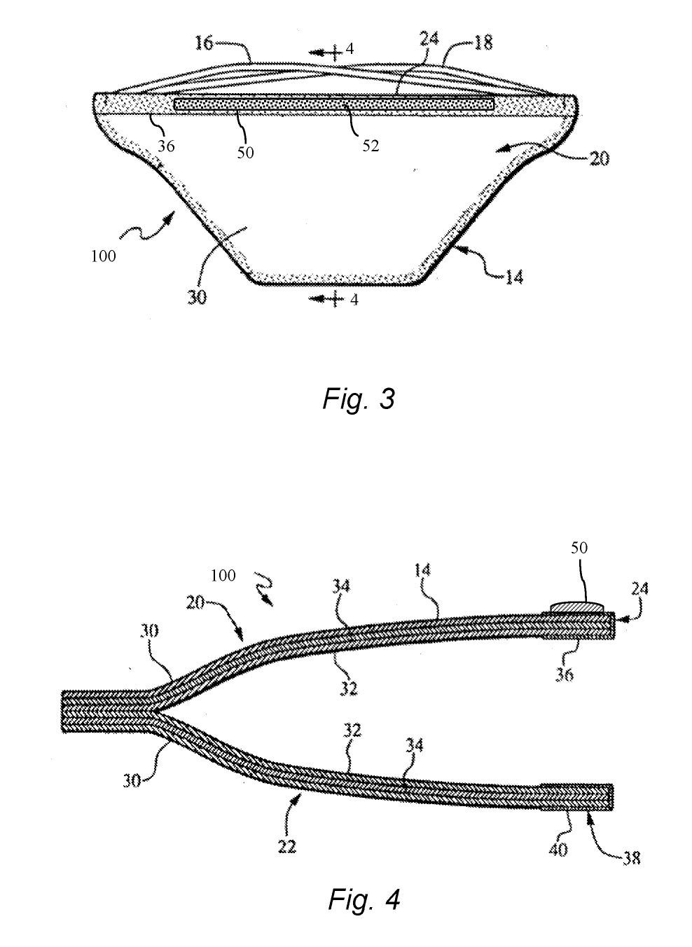

FIGS. 3 and 4 depict an embodiment of a facemask 100 in accordance with aspects of the present invention that incorporates a nose member 50, as described in greater detail below. As with the prior art masks of FIGS. 1 and 2, the upper and lower portions 20 and 22 of the mask include multiple layers, including an outer mask layer 30 and inner mask layer 32. Located between the outer and inner mask layers 30, 32 are one or more intermediate filtration layers 34. This intermediate layer 34 is typically constructed from a melt-blown polypropylene, extruded polycarbonate, melt-blown polyester, or a melt-blown urethane.

In addition, the top edge 24 of the mask 100 is faced with an edge binder 36 that extends across the open end of mask. Similarly, the bottom edge 38 is encompassed by an edge binder 40. The edge binders 36 and 40 are folded over and bonded to the respective edges 24, 30, and may be constructed from a spun-laced polyester material.

In accordance with the invention, the nose member 50 is deposited along the tope edge 24 essentially in the same location as the prior art nose wires so as to extend across the bridge of the wearer's nose and onto the cheek areas when the facemask 100 is properly donned. The nose member 50 includes a first reactant material 52 (indicated by the particles in FIG. 3), which in certain embodiments may be the entire composition of the initial nose member deposition 50. In other embodiments, the first reactant material 52 may be a component of the deposition 50. For example, the nose member deposition 50 may include a carrier material in which the first reactant material 52 is mixed. In a dried unreacted state, the first reactant material 52 (alone or in combination with other materials in the deposition 50) forms a malleable composition along the top edge 24 that is conformable across the wearer's nose and face when the mask 100 is donned by the wearer and the nose member 50 is manually manipulated by the wearer.

In the embodiment depicted in FIGS. 3 and 4, the nose member 50 is deposited on top of the binder material layer 36, and is thus exposed directly to the surrounding atmosphere or environment in which the facemask 100 is intended for use.

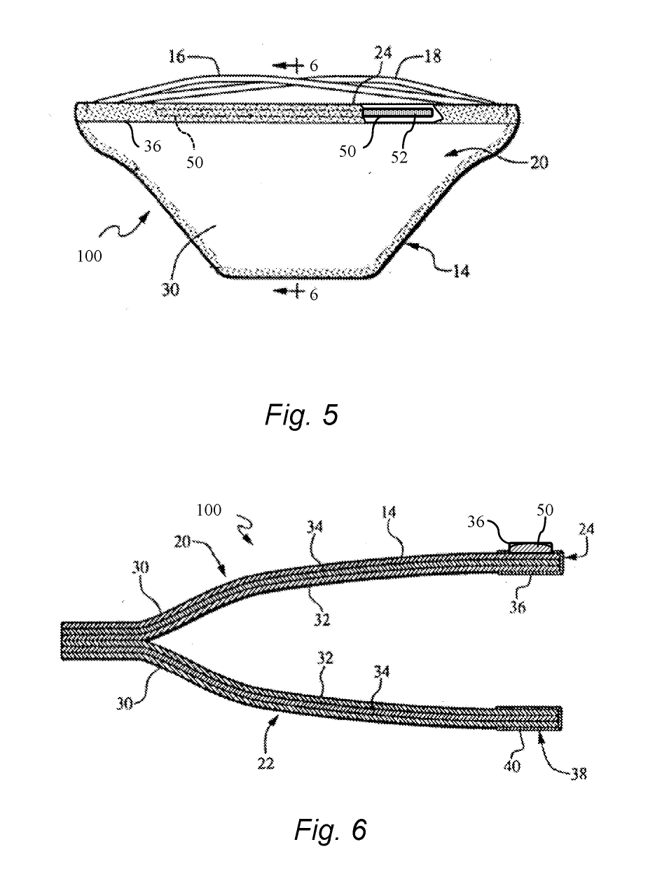

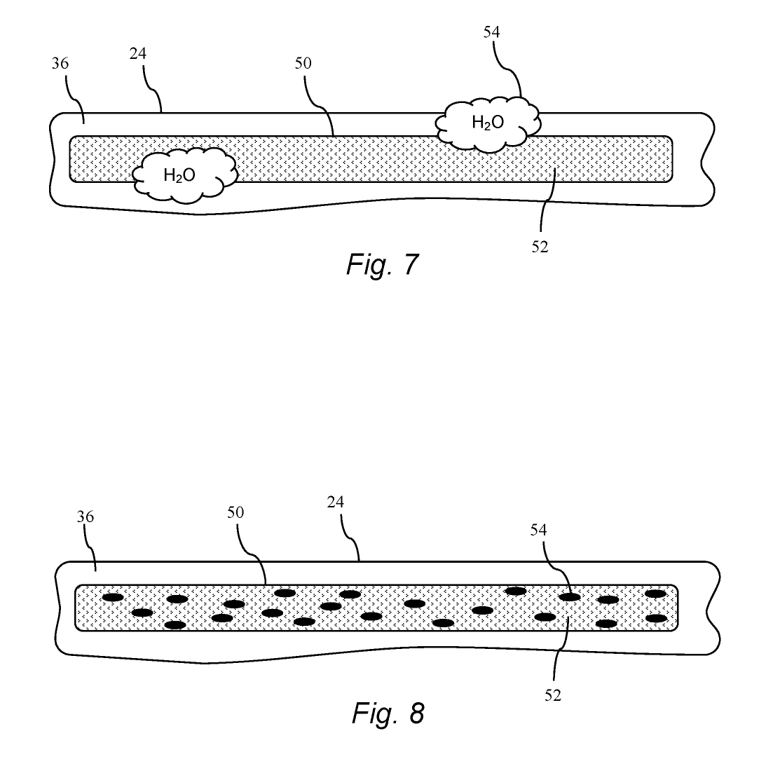

In the embodiment depicted in FIGS. 5 and 6, the nose member 50 is deposited on the body portion 20 under the binder material 36 such that the binder material 36 is folded over the first reactant material 52. This embodiment may be desired in that the binder material 36 isolates the wearer's skin from any reaction byproducts when the first reactant material 52 reacts with the second reactant material 54 (FIGS. 7 and 8), such as excessive heat, irritating gases or chemicals, and so forth. Certain reaction byproducts are not irritating or harmful to the wearer, such as heat, moisture, inert gases, and so forth. The binder material 36 also serves to envelope and ensure that the nose member 50 remains in position along the top edge 24.

As depicted in FIG. 7, in some embodiments, the nose member deposition 50 on the top edge 24 is a single-component composition containing the first reactant material 52, wherein the second reactant material 54 is external to the facemask. With this configuration, the first reactant material 52 is exposed to the second reactant material 54 upon unsealing the facemask 100 from a wrapper. For example, the second reactant material 54 may be contained in the atmosphere or environment where the facemask 100 is opened, such as humidity or moisture in the air as depicted in FIG. 7. In an alternate embodiment not directly depicted in the figures, the requisite moisture or other second reactant material 54 may be applied directly onto the first reactant material 52 by the wearer, for example, from a sprayer or a moist wipe.

With the embodiment depicted in FIG. 7, the first reactant material 52 may be a crosslinkable polymeric material that crosslinks with moisture 54 upon being exposed and then forms the stiffened nose member 50 that retains the conformed shape manually induced in the top edge 24 by the wearer upon donning the facemask 100. The crosslinkable polymeric material can be one of a cyanoacrylate or a polydimethyl siloxane that crosslinks with moisture present in the atmosphere upon being exposed.

Referring to FIG. 8, in still other embodiments, the nose member deposition 50 along the top edge 24 may be a two-component composition that also includes the second reactant material 54. With this type of deposition, the reactants 52, 54 are retained separate and isolated from each other until the mask 100 is donned by the wearer. For this, in certain embodiments, one or both of the first 52 and second reactant materials 54 are provided in encapsulated form and may be homogeneously mixed with the other respective reactant material. The encapsulated reactants 52, 54 may be mixed in a carrier material, wherein the composition of carrier material and encapsulated reactants is deposited along the top edge as the deposition material nose member 50. When donning the facemask 100, the wearer manipulates (e.g., kneads or squeezes) the top edge 24 to expose the encapsulated reactant(s) 52, 54 to each other. The reaction time of the reactants 52, 54 is sufficient to allow the wearer to conform the top edge 24 across their nose and face prior the nose member 50 assuming a stiffened state in the conformed shape.

In an example of the above embodiment, the first and second reactants 52, 54 may include a two-part acrylic resin, or a two-part epoxy system.

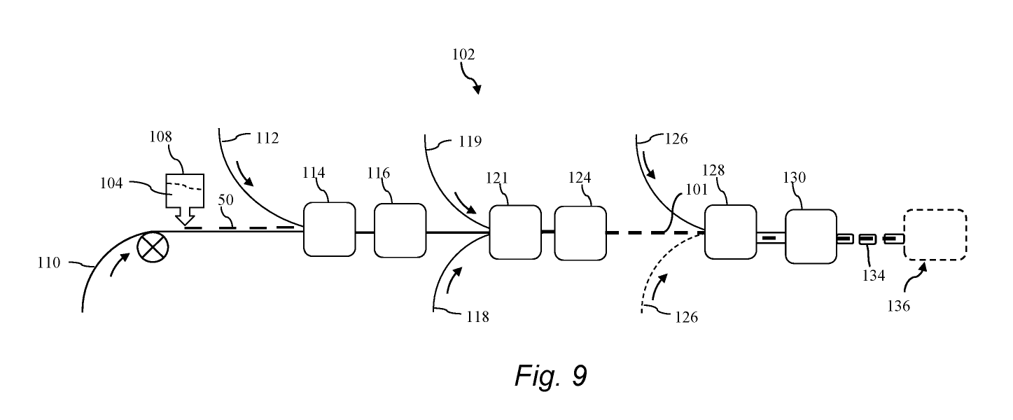

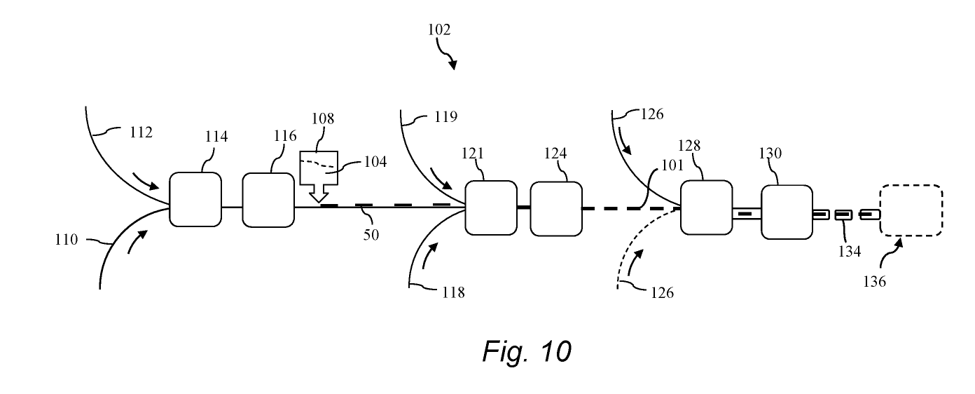

The present invention also includes various embodiments for manufacturing the above-described facemasks in a high throughput production line, embodiments of which are depicted in FIGS. 9 and 10. It should be appreciated, however, that the production lines of FIGS. 9 and 10 are not a limiting factor of the method, and are presented for exemplary purposes only. Those skilled in the art can configure any many of facemask production line that incorporates the method of the present invention, and all such production lines are within the scope and spirit of the invention.

Referring to FIG. 10, an exemplary production line 102 is depicted for manufacture of facemasks 100 incorporating the nose member 50 as described above with respect to FIGS. 3 and 4 where the nose member 50 is on top of the binder layer 36. A continuous web 110 is introduced from a source (e.g., a roll) and corresponds to the upper body portion 20 of the finished facemasks, wherein the upper portion 20 includes one or more intermediate layers 34, as described above.

The web is introduced along with a continuous binder web to a folding station 114 wherein the binder web 112 is folded around the respective running edge of the carrier web 110. The components then pass through a bonding station 116 wherein the binder webs 112 are thermally bonded to the carrier web 110, thereby producing the edge configuration 24 with binder material layer 36 depicted in FIGS. 3 and 4.

From the bonding station 116, the continuous combination of web 110 and thermally bonded binder web 112 is conveyed to a deposition station 108 where nose member material 104 is deposited so as to form the nose member 50 along the top edge of the facemasks. The nose member material 104 is in a flowable state so as to be deposited by an extruder-type machine, or the like. It should be appreciated that the deposition station 108 includes any manner of applying the flowable material 104 as a line across the edge of the web 110 directly onto the binder web material 112, including coating devices, spraying devices, printing devices, and so forth.

From the deposition station 108, the combination of webs with nose members 50 is conveyed to another bonding station 121. The distance between the stations 108 and 121 is sufficient to allow the nose members 50 to dry or partially solidify into the malleable form discussed above. At the bonding station 121, an additional web 118 is introduced that corresponds to the lower panel portion 22 of the facemask 100 depicted in FIGS. 3 and 4. As with the upper portion 20, this web 118 may include one or more intermediate layers 34 formed as described above. This web 118 may already have the binder web applied to the edge thereof from an upstream process. Continuous elastomeric straps 119 are also introduced and are laid between the edges of the web 118 and web 110 corresponding to the edges 24, 28 in FIG. 1. The materials are bonded together in a bond pattern that corresponds to the trapezoidal shape of the facemask 100 with a closed end and an open end at the edges 24, 28.

The bonded webs 110 and 118 (with nose member 50 and straps 119) are conveyed to a cutting station 124 wherein individual facemasks 101 are cut out from the webs and bonded along the lines indicated in FIGS. 3 and 4.

The facemasks 101 are then conveyed to another bonding station 128 wherein wrapping materials 126 (e.g. a poly material) are introduced and are folded (if necessary) and bonded around the individual facemasks 101. A single web of the wrapping material 126 may be folded around the facemasks and sealed along a continuous longitudinal bond line or, in an alternate embodiment an additional web of the wrapping material 126 may be introduced to the bonding station, wherein the facemasks are sandwiched between the two webs 126. The webs 126 are then sealed along continuous longitudinal bond lines along their mating edges.

A continuous stream of wrapped facemasks 132 emerge from the bonding station 128 and are conveyed to a cutting station 130 wherein cuts are made in the bonded wrapping material in a desired pattern to produce individual wrapped facemasks 134. These masks 134 are conveyed to downstream processing stations 136 for further processing, including stacking and packaging.

The production line 102 depicted in FIG. 9 relates to formation of the facemask 100 depicted in FIGS. 5 and 6 wherein the nose members 50 underlie the binder material layer 36 along the top edge 24. In this line 102, the deposition station 108 is operably configured upstream of introduction of the web 112 and deposits the flowable material 104 is discrete amounts directly onto the web 110 along the edge of the web corresponding to the top edge 24 of the facemask 100. The web 110 with individual nose members 50 deposited thereon are then conveyed to the folding and bonding stations 114, 116 wherein the web 112 is introduced and is folded and bonded around the edge of the web 110 so as to essentially encapsulate the nose members 50, as depicted in FIG. 6. The remaining portions of the line 102 in FIG. 10 are as described above with respect to FIG. 9.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A facemask, comprising:
a body comprising a top edge and a bottom edge, the top and bottom edges cooperating with each other to define a periphery that contacts a wearer's face;
a first reactant material deposited along the top edge, the first reactant material having a malleable unreacted state such that the top edge is conformable across a wearer's nose and face in the unreacted state;
the first reactant material reactable with a second reactant material to form a stiffened nose member that retains the conformed shape across the wearer's nose and face.

2. The facemask according to claim 1, wherein the top edge further comprises a binder material folded over the top edge, the first reactant material deposited on the body below the binder layer.

3. The facemask according to claim 1, wherein the top edge further comprises a binder material folded over the top edge, the first reactant material deposited on top of the binder material.

4. The facemask according to claim 1, wherein the second reactant material is external to the facemask, the first reactant material exposed to the second reactant material upon unsealing the facemask from a wrapper.

5. The facemask according to claim 4, wherein the first reactant material is a crosslinkable polymeric material that crosslinks with moisture upon being exposed.

6. The facemask according to claim 5, wherein the crosslinkable polymeric material comprises one of a cyanoacrylate or a polydimethyl siloxane that crosslinks with moisture present in the atmosphere upon being exposed.

7. The facemask according to claim 1, wherein the second reactant material is also deposited along the top edge.

8. The facemask according to claim 7, wherein one or both of the first and second reactant materials is provided in encapsulated form homogeneously mixed with the other respective reactant material, wherein the top edge is manipulated by the wearer prior to donning the facemask to release the encapsulated reactant.

9. The facemask according to claim 8, wherein the reactants are activated by pressure applied along the top edge by the wearer.

10. The facemask according to claim 8, wherein the first and second reactants comprise a two-part acrylic resin.

11. The facemask according to claim 8, wherein the first and second reactants are a two-part epoxy.

12. A method for manufacturing a facemask in a production line, comprising:
in the production line, forming a filter body of the facemask having a top edge and a bottom edge, the top and bottom edges cooperating with each other to define a periphery that contacts a wearer's face;
at a station along the production line, depositing a first reactant material along the top edge, the first reactant material having a malleable unreacted state such that the top edge is conformable across a wearer's nose and face in the unreacted state, the first reactant material reactable with a second reactant material to form a stiffened nose member that retains the conformed shape across the wearer's nose and face; and
preventing the first reactant material from reacting with the second reactant material prior to wearer donning and using the facemask.

13. The method according to claim 12, further comprising applying a binder material to the top edge at a station along the production line, the binder material folded over the top edge.

14. The method according to claim 13, wherein the first reactant material is deposited along the top edge under the binder material.

15. The method according to claim 13, wherein the first reactant material is deposited along the tope edge on top of the binder material.

16. The method according to claim 13, wherein the second reactant material is external to the facemask, wherein the preventing step further comprises sealing the facemask in wrapping material along the production line subsequent to deposition of the first reactant material to isolate the first reactant material from the second reactant material.

17. The method according to claim 16, wherein the first reactant material is a crosslinkable polymeric material that crosslinks with atmospheric or environmental moisture upon the wearer unsealing and donning the facemask.

18. The method according to claim 13, wherein the second reactant material is also deposited along the top edge, wherein one or both of the first and second reactant materials is provided in encapsulated form homogeneously mixed with the other respective reactant material, wherein the top edge is manipulated by the wearer prior to donning the facemask to release the encapsulated reactant.
